(19) United States
(12) Patent Application Publication
(10) Pub. No.: US 2015/0307368 A1
(43) Pub. Date: Oct. 29, 2015

(54) Ultraviolet Light Purification Drinking System

(71) Applicant: Richard D. Yanke, Burbank, CA (US)

(72) Inventor: Richard D. Yanke, Burbank, CA (US)

(73) Assignee: Richard D. Yanke, Burbank, CA (US)

(21) Appl. No.: 14/691,639

(22) Filed: Apr. 21, 2015

Related U.S. Application Data
(60) Provisional application No. 61/984,491, filed on Apr. 25, 2014.

(51) Int. Cl. C02F 1/32; C02F 1/28

(52) U.S. Cl. CPC C02F 1/325; C02F 1/283; C02F 2201/32

(57) ABSTRACT

The invention disclosed herein provides a UV purification system within a portable water bottle having a cap and container. More specifically, the present invention is a portable water bottle that provides UV disinfection and water storage having a cap that contains a ultraviolet (UV-C) emitting source to purify stored water for immediate use. Optionally, a carbon filter means is inserted between the cap and container to further purify the water.

### RELATED APPLICATIONS

This application claims the benefit of U.S. Provisional Patent Application No. 61/984,491, filed Apr. 25, 2015, the disclosure of which is incorporated herein by reference.

### FIELDS OF THE INVENTION

The invention presented here relates to an ultraviolet sterilization system used for removing or reducing microbes from bottled water prior to use, or more specifically a portable ultraviolet sterilization drinking system for reducing or removing microbes from drinking water.

### BACKGROUND

Each year millions of humans are infected with water borne pathogens. The World Health Organization has reported that 1.8 million people die every year from diarrheal disease, including cholera, 90% are children under 5 years old. These are preventable cases which are caused by drinking water contaminated with pathogens. This is mostly an issue within the developing regions, but also can become an issue in industrialized nations in times of war, or natural disasters such as floods, earthquakes, tsunamis, or any type of civil unrest or terrorism which may affect centrally distributed and disinfected tap water.

It is know that UV-C radiation is one type of energy source that is capable of disinfecting water. There are numerous methods and devices for ultraviolet radiation disinfection. UV-C disinfection mechanism is characterized by sufficiently exposing the DNA and/or RNA of micro-organisms to photon energies that can impart direct dissociation of the chemical chain, such as a break or nick in the chain, thereby disrupting the cellular replication cycle and continued growth of the organism. Higher photon energy with shorter wavelength photons, like ultraviolet light, produces much greater disinfection compare to visible light, UV-A, UV-B, or other sources. This is why ultraviolet light within the UV-C band (wavelength of approximately 210 nanometers to approximately 290 nanometers, also known as the “disinfection band”) is the most efficacious and preferred range for disinfection applications.

Wadstrom in U.S. Pat. No. 7,837,865 discloses a device using a combination of solar heat and ultraviolet light however, there are no ultraviolet disinfection parameters or indication mechanism, nor is there a means by which the user would know that the stored water has been irradiated and completely disinfected.

Lantis et al. in US Pat. Appl. No. 2013/0056425 described a solar-based portable water disinfection system. Lantis et al. utilizes a security cap seal wherein the seal is affixed around the base of the cap and cured with UV light to represent disinfected water. However, the bottle in Lantis et al does not address continued use after the seal is broken for use and subsequent UV disinfections are required.

There is a need for a practical device capable of rapidly purifying a small volume of water suing continued use. The present invention addresses this need using a portable device containing an ultraviolet irradiation source. It is well know that ultraviolet light (UVC) is one energy source that is capable of disinfecting water. Non-thermal disinfection mechanisms are well known and characterized by sufficiently exposing the DNA and/or RNA of micro-organisms to photon energies that can impart direct damage to the chemical compounds defining the DNA/RNA chain, thereby breaking the cellular replication cycle and continued growth of the organism.

### SUMMARY

The present invention describes a portable water purification system for use in a standard water bottle. Accordingly, a water bottle having a germicidal UV-C water purification unit includes a water container with a threaded opening at the top onto which a cap containing a UV-C ultraviolet light source and related components are housed to provide an irradiation cycle for disinfecting the volume of water stored in the reservoir container. One 90 second UV irradiation cycle provides a complete disinfecting treatment of 750 ml of water, suitable for drinking. The system is capable of providing up to 10,000 treatment cycles, completing a single cycle in 90 seconds. A UV-C bulb within the cap and system electronics provides sterilizing UV radiation. An LCD screen on the top of the cap verifies the process.

In addition, the device has a built in LED light for illuminating the immediate area around the user, making it useful as a lantern in remote locations. The LED is located on the cap for quick and easy activation. An optional carbon fiber filter insert is provided to additional remove particles, benefiting the taste and reducing the order.

The portable system provides safe drinking water in regions where water contaminants may be suspect. It is useful in camping, hiking, cycling, traveling, and general use.

The embodiments of the present invention are shown in the drawings and summarized below. It is to be understood, however, that there is no intention to limit the invention to the forms described in this Specification. One skilled in the art can recognize that there are numerous modifications that would embody the spirit and scope of the invention as expressed in the claims.

### DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein.

FIG. 1. Drawing showing cap attached to the top of the 750 ml water container. The cap houses the UV-C source to disinfect the water stored within the container.

FIG. 2. Drawing showing underside of cap with UV source and LED light.

FIG. 3. Diagram showing the steps associated in a 1 cycle UV purification procedure.

### DETAILED DESCRIPTION OF THE INVENTION

The device described in the present invention provides a system for significantly reducing or eliminating microbes found in bottled water where the source was from a suspect source such as, but not limited to, taps, streams, or spigots. The process generally requires filling up the 750 ml bottle from the source, turning on the device, agitating the water and drinking. The purification system eliminates or reduces bacteria, viruses and protozoan cysts and can be used either during the day or at night. Immediately after completing the disinfection process, the water is available to drink. Further, the purified water can be stored in the container after drinking and either treated again by the disinfection process or emptied and refilled to treat another 750 ml of water from a suspect source.

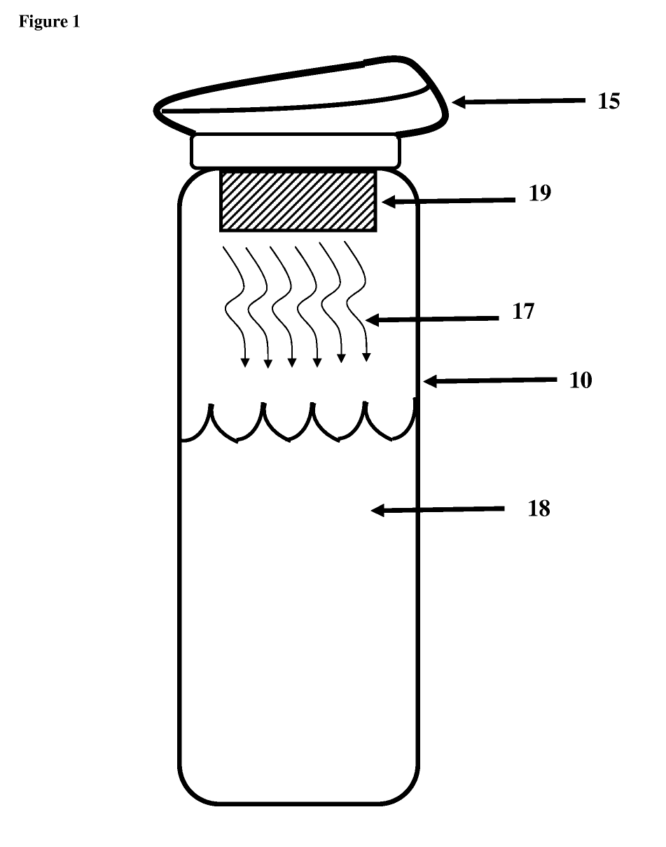

As shown in FIG. 1 the purification device contains a cap (15) housing the UV-C lamp, LED light, and associated electronic controls. The cap is threaded onto a 750 ml transparent container (10). The container is molded along the top lip of the opening to optionally support a carbon filter insert (19). With the carbon filter insert removed, the water (18) stored in the container (10) is exposed to UV-C irradiation (17). The carbon filter insert can be replaced for continued filtration during drinking.

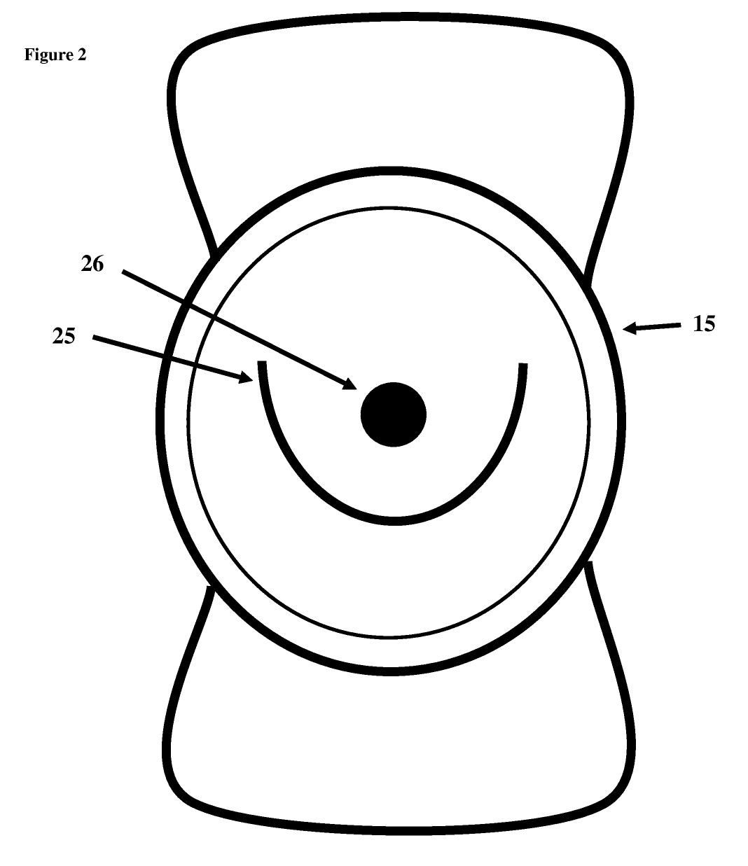

FIG. 2 shows the underside of the cap (15) which houses an insulated UV-C tube (25) arched around the LED light (26) in the center portion of the cap. An LCD display on the top of the cap (not shown) provides the countdown to the completed cycle which ensures that the water treatment is simple and intuitive. The cap can be used for 10,000 cycles. A USB cable plugs into the cap for recharging.

The device has applications in camping, hiking, outdoor use, indoor use, travel (hotel or airplane) or to use as an emergency source for water. It is easy to carry or can be attached to a bicycle or other transportation device.

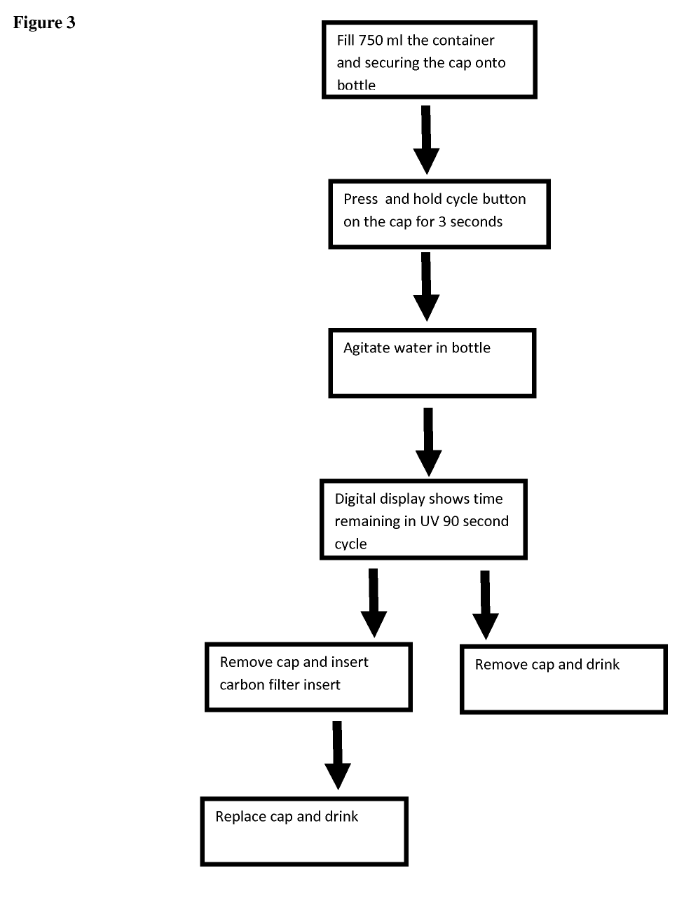

The device produces UV disinfected water through a quick and easy method of sterilization without the need of sunlight or other anti-microbial agents (see FIG. 3). Water is collected from a source with the 750 ml container bottle. The source can include water from taps, streams, spigots, and the like. Once collected the bottle is capped by rotating a threaded portion of the specialized UV-C emitting cap with the threaded portion of the container, forming a tightly sealed unit. A start button on the cap is pressed once and held for 3 seconds to begin the cycle. A digital display counts down from 90 seconds. The suspect water in the storage container is then agitated periodically. At 0 seconds the cycle is complete and the water is safe to drink, effectively and easily reducing microbe contaminants.

Following treatment by the UV-C source, the user can optionally unscrew the cap and replace the carbon filter insert. Carbon filtering acts to adsorb pollutant molecules or contaminants in the water and trap these molecules inside the pore structure of the carbon substrate, resulting in the further purification of the water. Typical particle sizes removed by carbon filters will range from 0.5 to 50 micrometers. The carbon filter component acts to remove chlorine, sediment, and volatile organic compounds to improve the taste and any odor in the water.

Another embodiment incorporates an LED light for use as a visible light source to illuminate the immediate area around the user when camping or such. As shown in FIG. 2, the LED light (26) is located in the center of the underside of the cap. Unscrewing the cap from the container or simply activating the light when attached to the container acts as a light source for an alternative use. Activation of the LED light is accomplished by pushing the activation button on the top of the cap for 3 seconds. The LED light can be turned off by pressing the same button once.

The cap having the UV-C source can be thoroughly cleaned by washing with a soft cloth and a mild soap solution. The soap is rinsed from the device and dried with a clean soft cloth.

The contents of the articles, patents, and patents applications and all other documents and electronically available information mentioned or cited herein, are hereby incorporated by reference in their entirety to the same extent as if each individual publication was specifically and individually indicated to be incorporated by reference.

The terms and expressions used herein have been used as terms of description and not of limitation, and there is no intention in the use of such terms of excluding any equivalents of the features shown and described or portions thereof. It is recognized that various modification are possible within the scope of the invention claimed. Thus, it should be understood that although the present invention has been specifically disclosed by preferred embodiments and other features, modification and variation of the invention embodied therein herein disclosed may be used by those skilled in the art, and that such modification and variations are considered to be within the scope of this invention.

I claim:

1. A drinking water purification and storage device comprising:
a. a container capable of holding suspect water, wherein the container is transparent to light, the container having a top and bottom wherein the top forms a treaded neck and the bottom comprises a concave shape for positioning upright;
b. a cap comprising an internal threaded portion as a tightening feature for attaching to the threaded neck; and
c. an ultraviolet light within the cap wherein activation of the ultraviolet light provides UV irradiation sufficient to disinfect suspect water for drinking.

2. The device of claim 1 wherein the container holds up to 750 ml of suspect water.

3. The device of claim 2 wherein the suspect water is from a group consisting of taps, streams and spigots.

4. The device of claim 1 wherein the top portion of the cap contains an LCD display for displaying and selecting disinfecting functions.

5. The device of claim 1 wherein the ultraviolet light is UV-C.

6. The device of claim 1 further having an LED light at the bottom center of the cap to provide illumination.

7. The device of claim 1 further having a carbon filter means on the inner portion of the opening of the container.

8. The device of claim 7 wherein the carbon filter means is an insert to hold the carbon filter at the opening of the container during drinking.

9. A method for disinfecting drinking water comprising:
a. filling a container of a device in claim 1 with suspect water;
b. replacing a cap of the device in claim 1 on the container;
c. pressing a cycle button on the cap for 3 seconds where pressing the button activates a UV light;
d. agitating the water in the device while the water is irradiated; and
e. removing the cap to drink the water.

10. The method of claim 9 wherein the container holds up to 750 ml of suspect water.

11. The method of claim 9 wherein pressing the cycle button irradiates the suspect water for 90 seconds.

12. The method of claim 9 wherein a carbon filter means is inserted at the opening of the container.

13. The method of claim 12 wherein the carbon filter removes 0.5 to 50 micron particles from the suspect water during drinking.

14. The method of claim 9 further having an LED lamp in the cap for illuminating the immediate area around the user.
